(19) United States
(12) Patent Application Publication
(10) Pub. No.: US 2016/0071028 A1
(43) Pub. Date: Mar. 10, 2016

(54) UPDATING TRAVEL DATA IN A SERVER DATABASE OF A CENTRALIZED MID-BACK OFFICE SYSTEM

(71) Applicant: Amadeus S.A.S., Sophia Antipolis (FR)

(72) Inventor: Luc Rous, Boechout (BE)

(21) Appl. No.: 14/482,234

(22) Filed: Sep. 10, 2014

(51) Int. Cl. G06Q 10/02; G06F 17/30

(52) U.S. Cl. CPC G06Q 10/02; G06F 17/30365; G06F 17/3051; G06Q 50/14

(57) ABSTRACT

Methods, systems, and computer program products for updating a server database of a centralized mid-back office system for travel agencies with travel data received from a remotely generated input data file. An input data file is received that includes travel fare data and travel reservation data related to a travel reservation. At least one rule is selected from a rules database for processing the travel fare data based at least in part on the travel reservation data. Travel fare values are determined from the travel fare data associated with the fare data fields based at least in part on the at least one rule. The travel fare data fields in the server database are updated with the travel fare data, and the travel reservation data fields in the server database are updated with the travel reservation data.

### BACKGROUND

The present invention generally relates to computers and computer software and, in particular, to methods, systems, and computer program products for updating a server database of a centralized mid-back office system for travel agencies with travel data received from a remotely-generated input data file.

Updating a server database of a centralized system may be performed by receiving, over a computer network, a remotely generated input data file that includes a number of values. The received input data file may be processed by a processing unit so as to extract the values corresponding to predetermined server database fields. After the values have been extracted, the processing unit updates the server database fields with the corresponding values, which may later be used in a number of ways, e.g., to provide product inventory reports or to keep a list of records up-to-date depending on the function of the centralized system.

In the context of updating a server database of a centralized mid-back office system for travel agencies, an input data may be received each time that a travel reservation is booked. A travel agent may create the input data file in connection with assisting a customer with a travel reservation request. The input data file may be a Passenger Number Record (PNR), which is a record in the database of a computer reservation system (CRS) that may contain the itinerary for a passenger, or a group of passengers traveling together, amongst other information. After the travel reservation has been booked, the travel data in the input data file is finalized and transmitted to the centralized mid-back office system. The input data file is processed by the centralized mid-back office system so as to extract the travel data associated with predetermined fields of the server database and, accordingly, update each of the server database fields with the corresponding travel data.

The travel data of the input data file may include data related to the travel reservation that corresponds to certain travel data fields of the server database and travel fare data that corresponds to other travel fare data fields of the server database. For example, the travel reservation data of the input data file may include travel-related information such as the passenger name, transportation carrier, pricing code, exchange ticket code and corporate affiliation program code. On the other hand, the travel fare data may include fare information of the travel reservation such as the published fare of the travel reservation, the sales price at which the reservation was sold to the customer, the purchase travel reservation price that the travel agency has to pay to the provider, the travel fare commission code determining the commission rate on the travel reservation, etc.

Given the number of different values provided with respect to the travel fare data, a processing unit of the centralized travel reservation system may be required to interpret the travel fare data of the input data file so as to correctly extract the travel fare values corresponding to the travel fare data fields of the server database. The interpretation of the travel fare data is performed by providing in the source code of the processing unit with a set of pre-programmed instructions or rules, which dictate the way the travel fare data is to be interpreted by the processing unit. These pre-programmed instructions are hard coded in the main source code of the processing unit.

Based on this set of pre-programmed instructions or rules, the travel fares values are extracted and, together with the travel reservation values, are used for updating the server database data fields. The values held in the server database data fields may then be used by the travel agency or other parties for issuing invoices to the customer, for determining the correct price to be paid to the provider of the travel reservation, for receiving sales commission from the supplier, and for accounting and reconciliation purposes.

However, the interpretation requirements of the travel fare data for each of the input data files received may differ greatly from one another. As a result, travel fare data exceptions may be formed that require specific interpretation instructions or rules, which may deviate from the pre-programmed instructions that are hard coded in the source code of the processing unit. The travel fare data exceptions may arise due to a number of different reasons, such as the travel market requirements, conditions imposed by the transportation carrier, customer affiliation discount programs, and so on. Therefore, if the pre-programmed instructions do not include specific instructions or rules dealing with the travel fare data exceptions of the input data file, the travel fare data may be incorrectly processed by the processing unit. As a result, the processing unit may incorrectly interpret the travel fare data of the input data file, leading to the update of the fare data fields of the server database with incorrect or inaccurate values, which will result in the issuance of incorrect invoices to the customers, improper reconciliation of accounting data, incorrect payment to the provider of the travel reservation, wrongly calculated sales commission, and so on.

The incorrect interpretation of the travel fare data is usually discovered at a much later stage, which may have significant financial consequences for all the parties involved in the travel reservation transactions, such as the travel agent, the customer, the supplier and the travel reservation management company. After the interpretation problem is discovered, the user of the input data file may raise an issue flag to the centralized mid-back office system for the resolution of the interpretation problem.

Resolving interpretation problems requires changing or updating the hard coded pre-programmed instruction, which may be performed by modifying the generic source code of the processing unit. Each time that a modification is made to the source code of the processing unit, a complete software testing needs to be performed to guarantee that the functionality of the processing unit has not been affected by any of the changes made to the pre-programmed instructions. Furthermore, because the mid-back office system is a generic system used by many users, a change to the hard coded pre-programmed instructions, although it may resolve an interpretation problem raised by one user, might affect the operation of the system for another user. As a result, completely resolving a single interpretation problem arising from the travel fare data contained in a single input data file may take a considerable amount of time, so as to ensure that none of the users using the mid-back office have been affected by the change to the hard-coded pre-programmed instructions.

Considering the size of the travel market worldwide, a significant amount of interpretation resolution requests may be generated each day. Because the interpretation problems may be different from one another, there is no standard way of resolving each interpretation resolution request in an easy and quick manner. Instead, each interpretation resolution request must be manually resolved by a team of developers, while ensuring through software testing that the functionality of the processing unit has not been affected by any changes made to the source code. Therefore, resolving an interpretation resolution request may require a significant amount of time and effort. At the same time, each modification made to the generic source code significantly increases the risk of causing a malfunction of the processing unit.

Improved methods, systems, and computer program products are needed for updating a server database of a centralized mid-back office system for travel agencies with travel data received from a remotely generated input data file.

### SUMMARY

Embodiments of the invention are directed to methods, systems, and computer program products for updating a server database of a centralized mid-back office system for travel agencies with travel data received from a remotely generated input data file.

In an embodiment, a method to update a server database includes receiving an input data file including travel fare data and travel reservation data related to a travel reservation, selecting at least one rule from a rules database for processing the travel fare data based at least in part on the travel reservation data, and determining travel fare values from the travel fare data associated with the fare data fields based at least in part on the at least one rule. The predetermined travel fare data fields in the server database are updated with the travel fare data, and the predetermined travel reservation data fields in the server database are updated with the travel reservation data.

In an embodiment, a system is provided for updating a server database. The system includes at least one processor and a memory coupled to the at least one processor. The memory includes program code configured to be executed by the at least one processor to cause the system to receive an input data file including travel fare data and travel reservation data related to a travel reservation, select, based on the travel reservation data, at least one rule from a rules database for processing the travel fare data, determine, based on the at least one rule, travel fare values from the travel fare data associated with the fare data fields, update the predetermined travel fare data fields in the server database with the travel fare data, and update the predetermined travel reservation data fields in the server database with the travel reservation data.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a diagrammatic view of centralized mid-back office system for a travel agency in accordance with an embodiment of the invention.

FIG. 2 is a diagrammatic view of a system for updating a server database with travel data in accordance with an embodiment of the invention.

FIG. 3 is a diagrammatic view of a fare interpretation processing module in accordance with an embodiment of the invention.

FIGS. 4 and 5 are diagrammatic views that illustrate changing the priority setting of the travel reservation data via the GUI of the fare interpretation processing module.

FIG. 6 is a diagrammatic view of the architecture of the fare interpretation processing module in accordance with an embodiment of the invention.

FIG. 7 is a diagrammatic view showing the operation of a mid-back office system in accordance with an embodiment of the invention.

### DETAILED DESCRIPTION

Generally, systems and methods are provided for enabling the processing of an input data file comprising travel fare data exceptions in a quick and easy manner without the need for modifying the generic source code of the processing unit.

According to embodiments of the invention, the system may include a processing unit, which is in direct communication with a database server over a wireless or wired computer communication network. The processing unit may be configured to receive a remotely-generated input data file via a computer communication network. The input data file may include, among other data, travel reservation data and travel fare data related to the travel reservation. For example, the travel reservation data may include travel related information such as, passenger name, travel itinerary, transportation carrier, etc, while the fare data may include fare related information such as the price of the travel reservation, the amount that the travel agent has to be pay to the supplier, the sales commission to be paid to the travel agent for the booking of the reservation, etc. The processing unit may be configured to process the input data file so as to extract the travel data associated with predetermined fields of the server database and accordingly update each of the server database fields with the corresponding travel values extracted from the travel data. For example, the database fields may include travel reservation data fields for containing travel reservation values and travel fare data fields for containing travel fare values. The travel reservation data fields and travel fare data fields of the database corresponding respectively to the travel reservation data and travel fare data of the input data file.

According to embodiments of the invention, the processing unit may include a fare interpretation processing module, which is configured to select, based on the travel data, at least one rule for processing the travel fare data from a database of rules. Based on the selected rule, the fare interpretation processing module may be configured to determine from the travel fare data the corresponding travel fare values associated with the travel fare data fields of the server database. The travel fare values determined by the fare interpretation processing module may be communicated to the processing unit at which the travel fare values are grouped together with the remaining travel data for updating each of the server database fields.

The use of a dedicated fare interpretation processing module for processing the travel fare data of the input file may permit the rules or instructions to be applied to the travel fare data without pre-programming into the source code at the processing unit. As a result, changes to the rules for handling travel fare data exceptions may be performed locally in the fare interpretation processing module in an easy and quick manner by simple updating the database of rules. Therefore, interpretation errors can be resolved in significantly less amount of time and without the need for changing the hard coded, generic, source code of the processing unit. Furthermore, the use of a fare interpretation processing module may enable each user connected to the centralized mid-back office system to have different settings with respect to the rules to be applied to the travel fare data. As a result, each user may independently specify the rules to be applied to the travel fare data without the risk for affecting other users connected to the same centralized mid-back office system.

According to embodiments of the invention, the rules to be applied by the fare interpretation processing module to the travel fare data may include a set of pre-defined type rules for handling travel fare data with standard interpretation requirements and a set of exception-type rules for handling travel fare data exceptions. The separation of the rules into standard rules and exception-type rules may alleviate the need for updating the complete set of rules each time that an interpretation error is identified. Instead, only a predetermined part of the rules database configured to hold the exception-type rules may be updated with a new set of exception-type rules for handling the interpretation problem identified. In this way, the time and effort required for updating the exception-type rules may be significantly reduced leading to a less complicated system for resolving an interpretation error, which can be operated by a user with little or no knowledge of computer software programming.

According to embodiments of the invention, the exception-type rules may be configured so that they are dynamically triggered by the information contained in the travel reservation data. As a result, if the travel fare data constitutes an exception case, the fare interpretation engine is configured to identify the travel fare data with exception requirements and automatically select from a rules database, based on the travel reservation data, the correct exception-type rule to be applied to travel fare data without the intervention of an operator. Therefore, the fare interpretation processing module for each input data file received can automatically identify and handle travel fare data with exception requirements and, based on the exception-type rule, determine the correct travel fare values associated with the travel fare data fields of the server database.

The correct travel fare values may then be sent to the processing unit where the correct travel fare values are grouped with the remaining travel reservation data for updating the server database fields. As a result, by automatically handling travel fare data with exception requirements, the database fields may be recurrently updated with the correct values, thereby significantly reducing the number of interpretation errors arising due to the incorrect interpretation of the travel fare data of the input data file.

According to embodiments of the invention, one or more exception-type rules to be applied to the travel fare data may be selected based on the priority settings given to the information contained in the travel reservation data. For example, from the travel reservation data, the information related to the exchange of the ticket may be assigned a higher priority than a customer affiliation program. As such, if the exchange ticket code information is present in the travel reservation data, a corresponding exception-type rule may be dynamically applied to the travel fare data by the fare interpretation processing module. If the exchange ticket code is not present in the travel reservation data, the fare interpretation processing module may sequentially go through the selected travel reservation information based on the priority settings until an exception-type rule is found.

The selection and prioritization of information from the travel reservation data may be used for creating unique combinations of exception-type rules to be applied to the travel fare data. For example, for a specific travel market in which specific rules apply to the exchange of a ticket, the information regarding the exchange tickets may be considered to be of a higher priority in comparison to the information related the corporate code of the customer. As a result, by changing the priority settings of the information contained in the travel reservation data one can enable the fare interpretation processing module to process travel fare data with specific exception requirements without the need for changing portions of fare interpretation processing module source code.

According to embodiments of the invention, the priority settings of the information contained in the travel reservation data may be defined through a graphical user interface (GUI). As a result, the priority setting may be easily changed by the user of the system through the GUI interface and without the need for changing the source code of the fare interpretation processing module. For example, the priority setting may be modified by changing the value of each of the fields using a computer keyboard to enter the corresponding value or by simple rearranging the fields using a computer mouse for performing drag-and-drop actions.

According to embodiments of the invention, the fare interpretation processing module may include an interpretation engine configured for processing the travel fare data so as to determine the type of the rule, either standard rule or exception-type rule, to be applied to the travel fare data. The use of an interpretation engine ensures that the travel fare data may be quickly analyzed without manual intervention by the operator of the system.

According to embodiments of the invention, the fare interpretation engine is configured to determine the type of the rule to be applied to the travel fare data based on the ratio between the travel fare amounts present in the travel fare data of the input data file. Since the number of travel fare amounts present in the travel fare data of the input data file is not standardized, each input data file may be provided with a different number of travel fare data amounts. For example, the travel fare data may include at least one travel fare amount. In another example, the travel fare data may include two or three or more travel fare amounts, which may all be different. The use of a ratio as a criterion for determining the type of a rule applying to the travel fare data may permit the fare interpretation engine to quickly analyze the travel fare data without using complicated formulas, thereby significantly reducing the processing power required for analysing the travel fare data and simplifying the fare interpretation engine architecture.

According to embodiments of the invention, the fare interpretation processing module may further include an exception-type rule interpretation engine configured for determining, based on the travel reservation data, whether an exception-type rule applies to the travel fare data. As a result, exception-type rules can be applied without the need for manual intervention by the operator of the system. As previously discussed, the exception-type rules may be based on the priority settings of the selected information from the travel reservation data.

According to embodiments of the invention, the exception-type rule interpretation engine may be further configured to issue an alert signal indicating that a new set of rules is required for processing the travel fare data. For example, an alert signal may be issued if the fare interpretation engine indicated that the travel fare data should be processed with an exception-type rule, but the exception-type rule interpretation engine is unable to find a corresponding exception-type rule based on the information contained in the travel reservation data. As a result, with the use of an alert signal, the risk for the server database fields being incorrectly updated with the wrong travel fare is significantly reduced because the operator of the system is always aware whether or not a corresponding rule has been found by monitoring whether an alert signal has been or has not been issued. Once alerted, the user may add a new set of rules in the rules database and process again the travel fare data. The database of rules may be part of the fare interpretation processing module or in direct communication with the fare interpretation processing module.

According to embodiments of the invention, the fare interpretation processing module may further include a calculation engine configured to determine, from the travel fare data, the corresponding travel fare values associated with the fare data fields of the server database based on the rule selected by the interpretation engine and the exception-type rule interpretation engine. Once calculated, the values are communicated to the processing unit at which the values are grouped with the remaining travel data so that the server database fields are updated. As a result, the risk of incorrectly updating the server database fields is significantly reduced.

A method may also be provided for updating a server database with travel data. According to embodiments of the invention, the method may include receiving a remotely-generated input data file via a computer network by a processing unit provided in direct communication with a database of a server. The input data file may include travel data comprising travel reservation data related to a travel reservation, and travel fare data related to the travel reservation. The input data file may then be processed by a processing unit so as to extract the travel data associated with predetermined fields of the server database. The database fields may then be updated by the processing unit updating each of the server database fields with the corresponding travel data, wherein the database fields include travel reservation data fields for containing travel reservation values and travel fare data fields for containing travel fare values. According to embodiments of the invention, the input data file may be processed by selecting, based on the travel data, and using a fare interpretation processing module that is part of the processing unit, at least one rule for processing the travel fare data from a database of rules and, based on the selected rule determining from the travel fare data, selecting the corresponding travel fare values associated with the fare data fields of the server database, which values are communicated to the processing unit where the values are grouped together with the remaining travel data for updating each of the server database fields. The travel fare data may be locally processed by the fare interpretation processing module to determine the travel fare values.

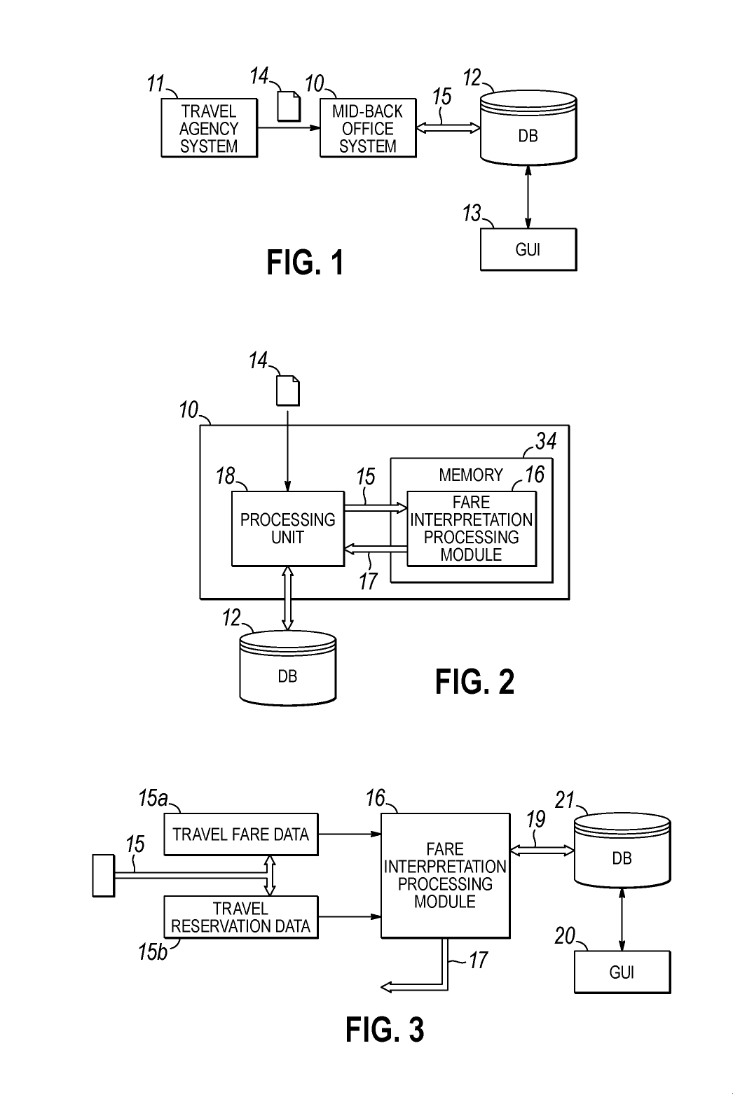

FIG. 1 shows an exemplified implementation of a centralized mid-back office system for travel agencies according to embodiments of the invention. The centralized mid-back office system may comprise a mid-back office system 10, which may be provided in direct communication with a Travel Agency (TA) system 11 and a server database 12. The mid-back office system may be configured for receiving input data files 14 from the Travel Agency (TA) system 11 containing travel data 15, which may be processed so as to extract travel data associated with predetermined fields of the server database 12. After the required travel data has been extracted, the server database fields may be updated with the corresponding travel values, which may be used later by the travel agency or other parties for issuing invoices to the customer, for determining the correct price to be paid to the provider of the travel reservation, for receiving sales commission from the supplier, and for accounting and reconciliation purposes. For this purpose, a Graphical User Interface (GUI) 13 may be provided so as to allow the travel agent or other parties to access the values stored in the server database 12.

With reference to FIGS. 2 and 3 in which like reference numerals refer to like features in FIG. 1 and in accordance with an embodiment of the invention, the mid-back office system 10 may be provided with one or more servers each including at least one processor or processing unit 18 configured for receiving and processing the travel data 15 of the input data file 14. The at least one processing unit 18 may include at least one hardware-based microprocessor and may be coupled with a memory 34. The memory 34 may represent the random access memory (RAM) comprising the main storage of the system 10, as well as any supplemental levels of memory, e.g., cache memories, non-volatile or backup memories (e.g., programmable or flash memories), read-only memories, etc. In addition, memory 34 may be considered to include memory storage physically located elsewhere in the system 10, e.g., any cache memory in a microprocessor, as well as any storage capacity used as a virtual memory, e.g., as stored on a mass storage device or on another computer coupled to the system 10.

For interface with a user or operator, the system 10 may include a user interface incorporating one or more user input/output devices, e.g., a keyboard, a pointing device, a display, a printer, etc. The display may be used to display, for example, a graphical user interface for interaction with the user or operator. Data may be communicated to and from another computer or terminal (e.g., the travel agency system 11) over a communication network, which may include one or more private and/or public networks (e.g., the Internet) that enable the exchange of data. The system 10 also may be in communication with one or more mass storage devices, which may be, for example, internal hard disk storage devices, external hard disk storage devices, external databases, storage area network devices, etc.

The system 10 typically operates under the control of an operating system and executes or otherwise relies upon various computer software applications, components, programs, objects, modules, engines, data structures, etc. In particular, the components may include a fare interpretation processing module 16, and may comprise instructions that may be resident and/or stored in the memory 34 or mass storage.

Moreover, various applications, components, programs, objects, modules, engines etc. may also execute on one or more processors in another computer coupled to the system 10 via the communication network, e.g., in a distributed or client-server computing environment, whereby the processing required to implement the functions of a computer program may be allocated to multiple computers over a network. For example, some of the functionality described herein as being incorporated into the system 10 and/or components of the system 10 may be implemented in one or more servers. Consistent with embodiments of the invention, the modules, applications, components and/or engines may be executing on one or more servers of the system 10, and may cause the processing unit 18 of the system 10 to perform operations consistent with embodiments of the invention.

The travel data 15 of the input data file 14 may include travel reservation data 15b related to the travel reservation, which corresponds to travel reservation data fields of the server database, and travel fare data 15a corresponding to travel fare data fields of the server database. For example, the travel reservation data 15b of the input data file 14 may include travel related information such as the passenger name, transportation carrier, pricing code, exchange ticket code, corporate affiliation program code, travel reservation issue ID, the tour code, the payment indicator, etc. The travel fare data 15a may include fare information of the travel reservation, such as the published fare of the travel reservation, the sales price that the travel reservation was sold to the customer, the price for the travel reservation that the travel agency has to pay to the provider, the travel fare commission code determining the commission rate on the travel reservation, and so on. With respect to the travel fare data 15a, each of the received input data files 14 may be provided with a different number of fares configured on respective lines, and each line may indicate a different fare amount.

The fare interpretation processing module 16 may be configured to select, based on the travel reservation data 15b, at least one rule 19 for processing the travel fare data 15a from a rules database 21, as shown in FIG. 3. The rules database 21 may include data and supporting data structures that store and organize data that is maintained and used by the system 10. In particular, the rules database 21 may be configured with any database organization and/or structure including, but not limited to, a relational database, a hierarchical database, a network database, and/or combinations thereof. A database management system in the form of a computer software application executing as instructions on the processing unit 18 of the system 10 may be used to access the information or data stored in records of the database 21 in response to a database query.

Based on the selected rule or rules 19, the fare interpretation processing module 16 is configured to process the travel fare data 15a so as to determine the corresponding travel fare values 17 associated with the travel fare data fields of the server database 12. The travel fare values 17 determined by the fare interpretation processing module 16 may then be communicated to the processing unit 18 where the travel fare values 17 may be grouped together with the remaining travel reservation data 15b for updating each of the server database fields.

The fare interpretation processing module 16 permits the application of rules 19 that are not pre-programmed into the source code of the processing module 18. As a result, any changes to the rules 19 for handling the exceptions in the travel fare data 15a may be performed locally in the fare interpretation processing module 16 by updating the rules database 21. Therefore, the fare interpretation processing module 16 identifies the interpretation problems to be resolved in a significantly less amount of time and without the need for changing the generic source code at the processing unit 18.

Furthermore, the fare interpretation processing module 16 may enable each user connected to the centralized mid-back office system 10 to have different settings with respect to the rules 19 to be applied to the travel fare data 15a. As a result, each user may independently specify the rules 19 to be applied to the travel fare data 15a without the risk for affecting the operation of other users connected to the same centralized mid-back office system 16.

The rules 19 in the rules database 21 may be separated into standard type rules for handling travel fare data 15a with standard interpretation requirements and exception-type rules for handling travel fare data 15a with exception requirements. For example, the standard rules may include a set of rules that are applied across the travel industry. On the other hand, the exception-type rules may include a set of rules that are applied only in certain cases and based on selected criteria such as the travel market, transportation carrier, etc. Dividing the rules 19 to be applied to the travel fare data 15a into standard and exception-type rules may significantly reduce the time and effort required for updating the rules database 21 because, if a new exception-type rule is needed, only the relevant database section may be updated. As a result, the downtime of the centralized mid-back office system 10 during a rule or rules update may be significantly reduced, leading to the faster resolution of an interpretation problem without the need for complete software testing of the source code of the processing unit 18. Moreover, because the exception-type rules can be updated without the need for a change to the hard coded source code of the fare interpretation processing module, the system 10 may be operated by a user with little or no knowledge of computer software programming

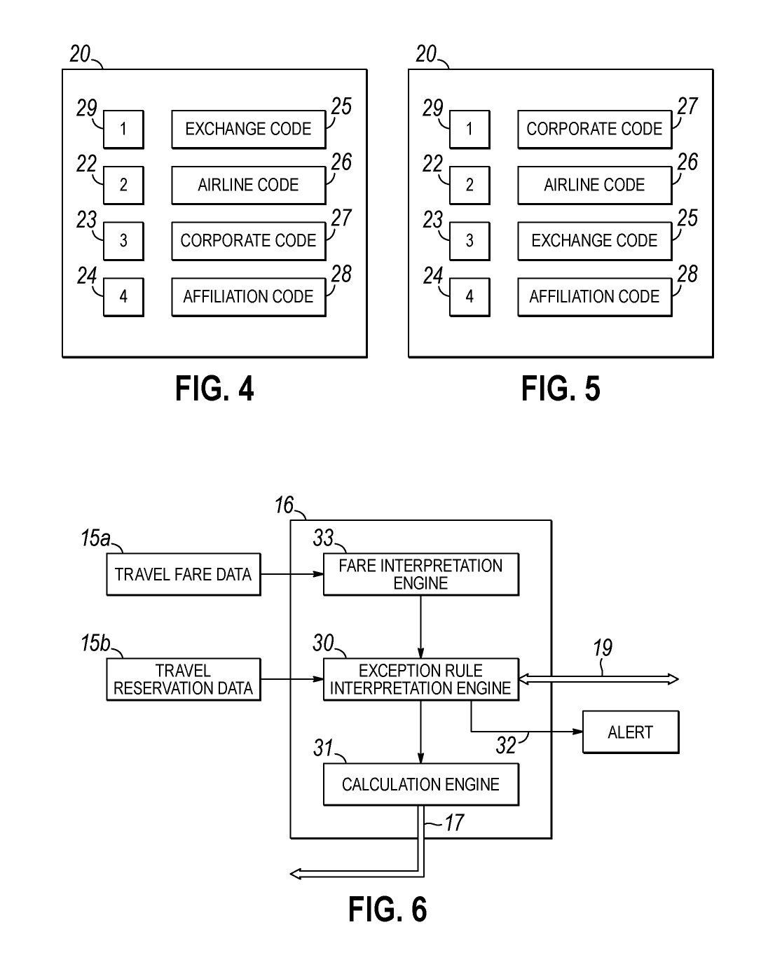

With reference to FIGS. 4 and 5 in which like reference numerals refer to like features in FIGS. 1-3 and in accordance with an embodiment of the invention, the exception-type rules may be configured so that they are dynamically triggered by the information 25, 26, 27, 28 contained in the travel reservation data 15b. As a result, if the travel fare data constitutes an exception case, the fare interpretation engine 16 is configured to identify the travel fare data 15a with exception requirements and automatically select from a rules database 21, based on the travel reservation data 15b, the correct exception-type rule to be applied to travel fare data 15a without the intervention of an operator. Therefore, the fare interpretation processing module 16 for each input data file received may automatically identify the rule to be applied for handling travel fare data 15a with exception requirements based on an exception-type rule selected from the rules database 21, which is used to determine the correct travel fare values 17 associated with the travel fare data fields of the server database 12.

According to embodiments of the invention, the exception-type rule or exception-type rules to be applied to the travel fare data 15a may be selected based on priority settings 22, 23, 24, 29 given to the information 25, 26, 27, 28 contained in the travel reservation data 15b. As shown in FIGS. 4 and 5, the priority settings 22, 23, 24, 29 of the information 25, 26, 27, 28 contained in the travel reservation data 15b may be quickly changed via a Graphical User Interface 20, thereby enabling the user to create unique combinations of exception-type rules to be applied to the travel fare data 15a. For example, the priority setting 22, 23, 24, 29 may be modified by changing the order of the information 25, 26, 27, 28 contained in each of the GUI 20 fields using a keyboard or by simple rearranging the information 25, 26, 27, 28 fields using a computer mouse. For example, for a specific travel market the information regarding the exchange code 25 of the airline ticket may be considered to be of a higher priority in comparison to the information related to the corporate code 27 of the customer, as shown in FIG. 4. As a result, if the exchange ticket code information 25 is present in the travel reservation data 15b, a corresponding exception-type rule may be dynamically applied to the travel fare data 15a by the fare interpretation processing module 16. Otherwise, the fare interpretation processing module 16 based on the priority settings 22, 23, 24, 29 may sequentially go through the selected travel reservation information 25, 26, 27, 28 until an exception-type rule is found. In another example, the corporate code 27 of the customer may be considered to be of a higher priority than the airline code 26 or the exchange ticket code 25, as shown in FIG. 5. It should be noted that other information of the travel reservation data 15b may be selected to dynamically trigger an exception-type rule.

With reference to FIG. 6 in which like reference numerals refer to like features in FIGS. 1-5 and in accordance with an embodiment of the invention, the fare interpretation processing module 16 may be provided with a fare interpretation engine 33, which is configured for receiving the travel fare data 15a, and determine based on the information provided therein the type of the rule 19, standard rule or exception-type rule, to be applied to the travel fare data 15a. The use of a fare interpretation engine 33 ensures that the travel fare data may be quickly analyzed to determine whether it constitutes an exception or a standard case and based on this information select a corresponding rule without a manual intervention by the operator of the system. For example, the fare interpretation engine 33 may be configured to determine the type of rule 19 to be applied to the travel fare data 15a based on the ratio between the travel fare amounts present in the travel fare data 15a of the input data file 14. Each input data file 14 may be provided with different number of travel fare amounts. For example, the travel fare data 15a may include at least one, at least two, at least three or more travel fare amounts, which may all be different from one another. It has been found that using the ratio between the different fare amounts mentioned in the travel fare data 15a as a criterion for determining the type of rule 19 to be applied to the travel fare data 15a may significantly reduce the time and effort required by the fare interpretation engine to determine whether the travel fare data 15a constitutes an exception or a standard case. As a result, the fare interpretation engine 33 may quickly analyze the travel fare data 15a without using complicated mathematical formulas or other type of information, thereby significantly reducing the architecture complexity of the fare interpretation engine 33 and the processing power required thereof.

The fare interpretation processing module 16 may further include an exception-type rule interpretation engine 30, which is in direct communication with the fare interpretation engine 33. The exception-type rule interpretation engine 30 may be configured for receiving the results from the fare interpretation engine 33 and determine based on the travel reservation data 15b whether an exception-type rule applies to the travel fare data 15a. As a result, exception-type rules may be applied to the travel fare data 15a without manual intervention by the operator of the system. As previously discussed the exception-type rules applied may be based on the priority settings 22, 23, 24, 29 of the selected information 25, 26, 27, 28 contained in the travel reservation data.

As shown in FIG. 6, the exception-type rule interpretation engine 30 may further be configured for issuing an alert signal 32 to indicate that a rule 19 for processing the travel fare data 15a has not been found and that a new set of rules needs to be determined in the rules database 21. For example, an alert signal 32 may be issued if the fare interpretation engine 33 indicated that the travel fare data 15a should be processed with an exception-type rule but the exception-type rule interpretation engine 30 is unable to find a corresponding exception-type rule based on the travel reservation data 15a. As a result, with the use of an alert signal 32 the risk for the server database fields being incorrectly updated with the wrong travel fare is significantly reduced, since the operator of the system is always informed by the system whether the travel fare data have been correctly processed or not by monitoring whether an alert signal 32 has been issued or not by the exception-type rule interpretation engine 30. After being alerted, the user may add a new set of rules 19 in the rules database 21 and process again the travel fare data 15a. The rules database 21 may be part of the fare interpretation processing module 16 or may be in direct communication with the fare interpretation processing module 16 via a communication network.

According to embodiments of the invention, the fare interpretation processing module 16 may further include a calculation engine 31 configured for applying at least one that is selected by the fare interpretation engine 33 and exception-type rule interpretation engine 30, and calculating, based on the selected one or more rules, the travel fare values 17 corresponding to the travel fare data fields of the server database 12. In one embodiment, a single rule may be selected by the fare interpretation engine 33 and exception-type rule interpretation engine 30 and then applied by the calculation engine 31 as a basis for the calculation. After being calculated, the travel fare values 17 are communicated to the processing unit 18 where they are grouped with the remaining travel data 15b for updating the server database fields. As a result, the risk of incorrectly updating the server database fields may be significantly reduced.

It should be noted that the system according embodiments of the invention may be implemented in a single processor unit of a computer system. The system of the invention may be further implemented as a computer program product which can be loaded into a processing unit of a computer system. Furthermore, each feature of the system may be implemented in separate computer systems, which may be located in different locations, each communicating with one another via a computer communication network, which can be either wired or wirelessly implemented.

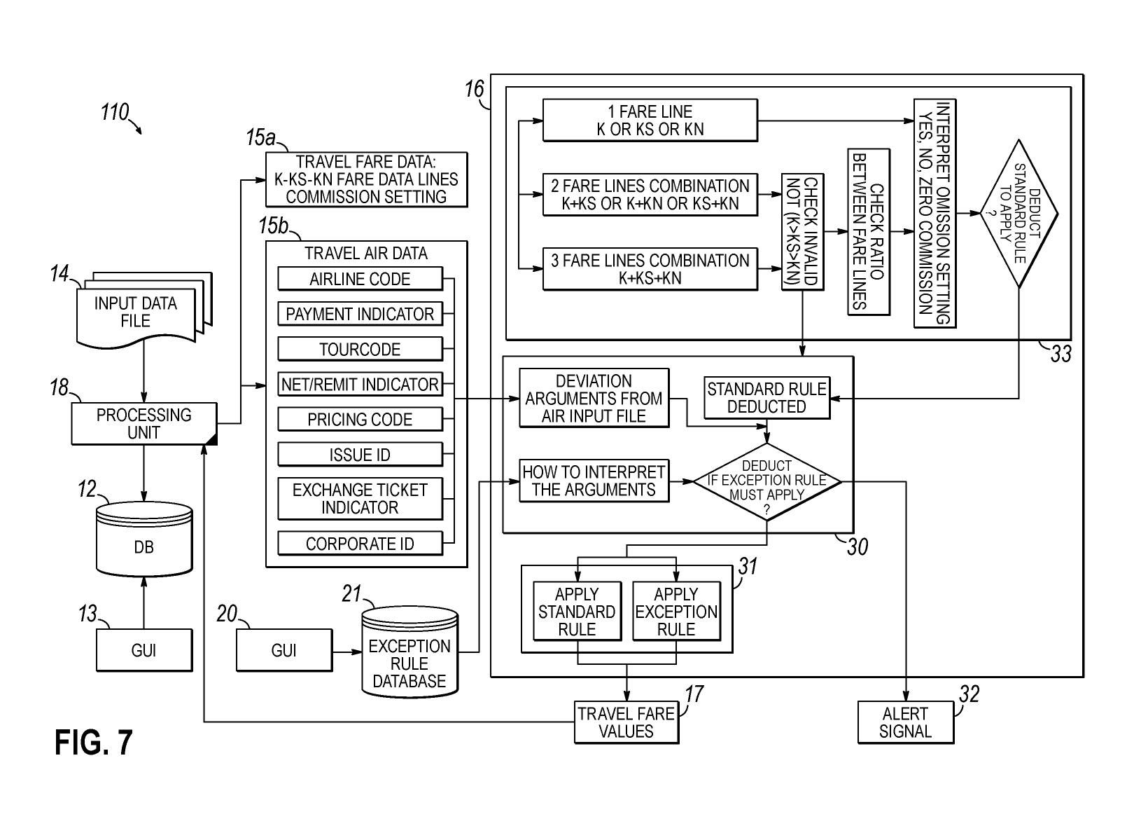

With reference to FIG. 7 in which like reference numerals refer to like features in FIGS. 1-6 and in accordance with an embodiment of the invention, a mid-back office system 110 may operate as the centralized mid-back office system 10, and the processing unit 18 of the mid-back office system 110 may be configured as a hand-off handler that is configured to receive the remotely-generated input data file 14, which includes travel data 15 related to a travel reservation. The travel data 15, as previously explained, may include travel fare data 15a and travel reservation data 15b related to the travel reservation. The travel fare data 15a may be provided with a number of different fare data lines, each corresponding to a different fare amount. For example, the actual price of the travel reservation may be denoted by the letter “K”, the sales price of the travel reservation paid by the customer may be denoted with the letters “KS”, and the purchase price of the travel reservation to be paid by the travel agent may be denoted with the letters “KN”. The travel fare data 15a may further include a fare data line related to the sales commission and how it should be calculated. For example, the fare data line related to the commission may indicate that no commission is to be calculated or that the commission should be zero or that the sales commission should be calculated based on predetermined percentage, e.g., 5%. The travel reservation data 15b may include information related to the travel reservation such as the Airline code, the payment indicator, the tour code, net/remit ticket code, pricing code, etc.

The fare interpretation processing module 16 of the AGM system 10 is in direct communication with the processing unit 18. The fare interpretation processing module 16 may include a fare interpretation engine 33 that is configured to receive the travel fare data 15a and, based on the number of fare data lines detected, to determine whether a standard rule or an exception-type rule applies to the travel fare data 15a. For example, if the travel fare data 15a includes only one fare data line e.g., K, KS or KN, the fare interpretation engine 33 may then proceed with the interpretation of the commission information so as to determine whether a commission should be applied and at what rate, followed by determining whether a standard rule should be deducted. However, if the travel fare data 15a includes two or more fare data lines, then the fare interpretation engine 33 may first check whether the amounts mentioned in each fare data line comply with predetermined criteria, such as that K>KS>KN, before checking the ratio between the fare data lines, interpreting the commission settings and finally determining whether a standard rule should be applied. If the predetermined criteria are not met, then the fare interpretation engine 33 automatically determines that the travel fare data 15a should be processed with an exception-type rule.

The exception-type rule interpretation engine 30 may process the output of the fare interpretation engine 33. The exception-type rule interpretation engine 30 may be configured for processing the travel fare data 15a and, based on selected information from the travel reservation data 15b, apply an exception-type rule from the rules database 21. As discussed hereinabove, priority settings may be applied to the information of the travel reservation data 15b via the GUI 20 interface. The exception-type rule interpretation engine 30 may be configured for processing the travel fare data 15a irrespective of whether the fare interpretation engine 33 has determined or not that a standard rule should apply. Furthermore, the exception-type rule interpretation engine 30 may be further configured to issue an alert signal 32 if a corresponding rule for processing the travel fare data 15a is not found.

The calculation engine 31 of the fare interpretation processing module 16 may be configured, based on the rule selected by the fare interpretation engine 33 and the exception-type rule interpretation engine 30, to determine the travel fare values 17 corresponding to the travel fare data fields of the server database 21. The travel fare values 17 may be communicated to the processing unit 18 where the travel fare values 17 are grouped together with the remaining travel reservation data 15b for updating the corresponding travel data fields of the server database 21. The values stored in the server database 21 may then be accessed via the Graphic User Interface (GUI) 13 by the travel agent or other parties involved in the travel reservation for issuing invoices, accounting reconciliation purposes, etc.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method to update a server database, the method comprising:
receiving, by a processor, an input data file including travel fare data and travel reservation data related to a travel reservation;
selecting, by the processor, at least one rule from a rules database for processing the travel fare data based at least in part on the travel reservation data;
determining, by the processor, travel fare values from the travel fare data associated with the fare data fields based at least in part on the at least one rule;
updating, by the processor, a plurality of travel fare data fields in the server database with the travel fare data; and
updating, by the processor, a plurality of travel reservation data fields in the server database with the travel reservation data.

2. The method of claim 1 wherein the rules database includes a plurality of exception-type rules for handling travel fare data exceptions, and selecting, based on the travel reservation data, at least one rule from the rules database for processing the travel fare data comprises:
dynamically triggering the selection of the at least one rule from the exception-type rules based upon information contained in the travel reservation data.

4. The method of claim 1 wherein the rules database includes a plurality of exception-type rules for handling travel fare data exceptions, and selecting, based on the travel reservation data, at least one rule from the rules database for processing the travel fare data comprises:
selecting the at least one rule from the exception-type rules based on priority settings of information contained in the travel reservation data.

5. The method of claim 1 wherein the rules database includes a plurality of pre-defined type rules for handling travel fare data with standard interpretation requirements and a plurality of exception-type rules for handling travel fare data exceptions, and selecting, based on the travel reservation data, at least one rule from the rules database for processing the travel fare data comprises:
determining whether the at least one rule to be applied to the travel fare data is one of the pre-defined type rules or one of the exception-type rules based on a ratio between predetermined travel fare amounts present in the travel fare data of the input data file.

6. The method of claim 1 the rules database includes a plurality of exception-type rules for handling travel fare data exceptions, and selecting, based on the travel reservation data, at least one rule from the rules database for processing the travel fare data comprises:
determining whether the at least one rule that applies to the travel fare data is one of the exception-type rules based on the travel reservation data.

7. The method of claim 1 wherein the rules database includes a plurality of pre-defined type rules for handling travel fare data with standard interpretation requirements and a plurality of exception-type rules for handling travel fare data exceptions, and further comprising:
issuing an alert signal indicating that a set of rules different from the pre-defined type rules and different from the exception-type rules is required for processing the travel fare data.

8. A system for updating a server database, the system comprising:
at least one processor; and
a memory coupled to the at least one processor, the memory including program code configured to be executed by the at least one processor to cause the system to:
receive an input data file including travel fare data and travel reservation data related to a travel reservation;
select, based on the travel reservation data, at least one rule from a rules database for processing the travel fare data;
determine, based on the at least one rule, travel fare values from the travel fare data associated with the fare data fields;
update the predetermined travel fare data fields in the server database with the travel fare data; and
update the predetermined travel reservation data fields in the server database with the travel reservation data.

9. The system of claim 8 wherein the rules database includes a plurality of exception-type rules for handling travel fare data exceptions, and the program code configured to be executed by the at least one processor to cause the system to select, based on the travel reservation data, at least one rule from the rules database for processing the travel fare data comprises:
program code configured to be executed by the at least one processor to cause the system to dynamically trigger the selection of the at least one rule from the exception-type rules based upon information contained in the travel reservation data.

10. The system of claim 8 wherein the rules database includes a plurality of exception-type rules for handling travel fare data exceptions, and the program code configured to be executed by the at least one processor to cause the system to select, based on the travel reservation data, at least one rule from the rules database for processing the travel fare data comprises:
program code configured to be executed by the at least one processor to cause the system to select the at least one rule from the exception-type rules based on priority settings of information contained in the travel reservation data.

11. The system of claim 10 further comprising:
a display including a graphical user interface configured to receive the priority settings.

12. The system of claim 8 wherein the rules database includes a plurality of pre-defined type rules for handling travel fare data with standard interpretation requirements and a plurality of exception-type rules for handling travel fare data exceptions, and the program code is further configured to be executed by the at least one processor to cause the system to:
determine whether the at least one rule to be applied to the travel fare data is one of the pre-defined type rules or one of the exception-type rules based on a ratio between predetermined travel fare amounts present in the travel fare data of the input data file.

13. The system of claim 8 wherein the rules database includes a plurality of exception-type rules for handling travel fare data exceptions, and the program code configured to be executed by the at least one processor to cause the system to select, based on the travel reservation data, at least one rule from the rules database for processing the travel fare data comprises:
program code configured to be executed by the at least one processor to cause the system to determine, whether the at least one rule that applies to the travel fare data is one of the exception-type rules based on the travel reservation data.

14. The system of claim 8 wherein the rules database includes a plurality of pre-defined type rules for handling travel fare data with standard interpretation requirements and a plurality of exception-type rules for handling travel fare data exceptions, and the program code is further configured to be executed by the at least one processor to cause the system to:
issue an alert signal indicating that a set of rules different from the pre-defined type rules and different from the exception-type rules is required for processing the travel fare data.

15. A computer program product for updating a server database, the computer program product comprising:
a non-transitory computer readable storage medium; and
instructions stored on the non-transitory computer readable storage medium that, when executed by a processor, cause the processor to:
receive an input data file including travel fare data and travel reservation data related to a travel reservation;
select, based on the travel reservation data, at least one rule from a rules database for processing the travel fare data;
determine, based on the at least one rule, travel fare values from the travel fare data associated with the fare data fields;
update the predetermined travel fare data fields in the server database with the travel fare data; and
update the predetermined travel reservation data fields in the server database with the travel reservation data.
